(19) United States
(12) Patent Application Publication
(10) Pub. No.: US 2014/0144834 A1
(43) Pub. Date: May 29, 2014

(54) MEMBRANE WITH TITANIUM DIOXIDE NANOSTRUCTURE AND METHOD FOR FABRICATING THE SAME

(71) Applicants: Seok Won HONG, Seoul (KR); Ha Na Yoo, Pocheon-si (KR); Subramaniya Pillai Ramasundara, Seoul (KR); Jae Sang Lee, Pyeongtaek-si (KR)

(72) Inventors: Seok Won HONG, Seoul (KR); Ha Na Yoo, Pocheon-si (KR); Subramaniya Pillai Ramasundara, Seoul (KR); Jae Sang Lee, Pyeongtaek-si (KR)

(21) Appl. No.: 13/689,191

(22) Filed: Nov. 29, 2012

(51) Int. Cl. B01D 71/02

(52) U.S. Cl. CPC B01D 71/024
USPC 210/500.25; 427/458

(57) ABSTRACT

The present disclosure relates to a separation membrane with a titanium dioxide nanostructure bound thereto, wherein titanium dioxide in the form of nanowire is fixed to the separation membrane by means of a polymer nanostructure so as to prevent a decrease of the specific surface area and separation performance of the membrane and thus removal of pollutants by the separation membrane and photo oxidative degradation by titanium dioxide in the form of nanowire can be maximized, and a method for fabricating the same.

### CROSS-REFERENCE TO RELATED APPLICATION

This application claims priority to Korean Patent Application No. 10-2012-0069109, filed on Jun. 27, 2012, and all the benefits accruing therefrom under 35 U.S.C. §119, the contents of which in its entirety are herein incorporated by reference.

### BACKGROUND

1. Field

The present disclosure relates to a separation membrane with a titanium dioxide nanostructure bound thereto and a method for fabricating the same. More particularly, the present disclosure relates to a separation membrane with a titanium dioxide nanostructure bound thereto, wherein titanium dioxide in the form of nanowire is fixed to the separation membrane by means of a polymer nanostructure so as to prevent a decrease of the specific surface area and separation performance of the membrane and thus removal of pollutants by the separation membrane and photo oxidative degradation by titanium dioxide in the form of nanowire can be maximized, and a method for fabricating the same.

2. Description of the Related Art

More than 43,000 kinds of chemicals are used in Korea and the use of chemicals is increasing every year. When various chemicals are discharged into the environment, it is not easy to accurately estimate their compositions and properties. They may remain in the environment without being naturally degraded and, thus, threaten human beings and animals. Recently, regulations on pollutants are becoming stricter as the social and individual concerns over the environment are gradually increasing. Therefore, methods for effectively processing various water pollution-causing chemicals, nanomaterials, endocrine disruptors, trace pollutants, etc. are being developed.

The existing water treatment processes are mainly based on biological treatment using microorganisms, which are limited in processing trace pollutants. Accordingly, adsorption using, for example, activated carbon, membrane separation, advanced oxidation, or the like are employed as auxiliary means for processing trace hazardous substances. The adsorption process is a procedure of separating particular components in water by attaching them on the surface of an adsorbent such as activated carbon and has been used for a long time. But, since it is a simple physical separation process based on adsorption, it cannot treat trace pollutants fundamentally and its effect is only limited.

The separation process using a membrane is drawing a lot of attentions since it enables separation of not only pollutants but also trace materials. Treatment of pollutants using a separation membrane is disclosed, for example, in Korean Patent Registration No. 992827 (Wastewater purification system using membrane separation) and Korean Patent Registration No. 1023437 (Advanced water treatment apparatus using biofilter and membrane). However, there is a limit to removal of dissolved organic pollutants only with the separation membrane and a fouling problem occurs as contaminants such as organic substances, colloids, microorganisms, etc. are accumulated on the surface.

The advanced oxidation process is a procedure of producing strongly oxidative OH radicals as intermediates to treat hazardous materials. In particular, titanium dioxide (TiO₂) is highly esteemed as a photocatalyst that produces OH radicals. Since it enables sterilization of microorganisms and degradation of hazardous tiny materials under UV light or sunlight, many researches are underway in the field of water treatment. Water treatment techniques using photocatalysts are disclosed, for example, in Korean Patent Registration No. 0438668 (Advanced oxidation processing system using photocatalytic reaction), Korean Patent Registration No. 0720035 (Water treatment apparatus and method using photocatalyst) and Korean Patent Registration No. 0784509 (Photocatalytic wastewater treatment unit and gas mixing type wastewater treatment apparatus having the same). However, if the photocatalyst is directly dispersed in powder form, an additional process of recovering the photocatalyst using a separation membrane is necessary to separate from treated wastewater after use and recycle the photocatalysts.

Meanwhile, efforts are being made to more effectively remove trace pollutants using both the separation membrane and the photocatalyst. In patents such as Korean Patent Registration No. 0503233 (Preparation of photocatalytic thin film and water treatment apparatus using the same), Korean Patent Registration No. 0643096 (Method for preparing titanium dioxide nanostructure using polycarbonate membrane and titanium dioxide nanostructure for photocatalyst prepared thereby) and Korean Patent Registration No. 0886906 (Method for manufacturing titanium separation membrane having nanoporous photocatalytic titania surface), a photocatalytic compound is added to a porous support layer by immersion or the template synthesis technique is employed to synthesize a titanium dioxide nanostructure. However, the immersion method such as sol-gel method for fixing the photocatalyst on the separation membrane may reduce reaction efficiency due to decreased specific surface area. Also, it negatively affect the permeation ability owing to increased coating layer thickness. And, the employment of the template synthesis technique may cause exfoliation problem due to weak adhesion.

### REFERENCES OF THE RELATED ART

### Patent Document

(Patent document 1) Korean Patent Registration No. 503233
(Patent document 2) Korean Patent Registration No. 643096
(Patent document 3) Korean Patent Registration No. 886906

### SUMMARY

In consideration of the aforesaid problems, the present disclosure is directed to providing a separation membrane with a titanium dioxide nanostructure bound thereto, wherein titanium dioxide is fixed to the separation membrane by means of a polymer nanostructure to prevent a decrease of the specific surface area or separation performance of the separation membrane and thus separation of pollutants by the membrane and oxidative degradation by titanium dioxide can be maximized, and a method for fabricating the same.

In an aspect, the present disclosure provides a method for fabricating a separation membrane with a titanium dioxide nanostructure bound thereto, including: laminating a polymer nanostructure on a separation membrane; forming a titanium dioxide nanostructure; and fixing the titanium dioxide nanostructure to the separation membrane by hot pressing, wherein the laminating the polymer nanostructure on the separation membrane comprises: preparing a mixture solution including a polymer precursor and the separation membrane; and electrospinning the mixture solution to deposit a polymer nanowire on the separation membrane.

The polymer nanostructure is provided between the separation membrane and the titanium dioxide nanostructure and confers adhesive property to the titanium dioxide nanostructure. The polymer precursor may be polyvinylidene fluoride (PVDF) or one of one of polypropylene (PP), polyimide (PI) polysulfone (PSF), polyethersulfone (PES), polyetherimide (PEI) and polyphenylene sulfide (PPS). And, the mixture solution including the polymer precursor may include the polymer precursor, acetone and N,N-dimethylformamide.

The production of the titanium dioxide nanostructure includes: preparing a mixture solution including a titanium dioxide precursor and a substrate; electrospinning the mixture solution to deposit a titanium dioxide nanowire on the substrate; controlling the crystalline phase ratio of the titanium dioxide nanostructure.

In the controlling the crystalline phase ratio of the titanium dioxide nanostructure, the ratio of anatase phase to rutile phase is controlled to 8:2-7:3. And, the separation membrane with the titanium dioxide nanostructure laminated is sintered at 500-600° C. Further, the mixture solution including the titanium dioxide precursor comprises of ethanol and a polymer binder for viscosity control.

The spinning of the mixture solution including the titanium dioxide precursor can be performed at a rate of 3-5 mL/min. And, the membrane having a plurality of pores and which can be made of either metal, ceramic or polymer material may be used as a separation membrane.

The fixing of the titanium dioxide nanostructure to the separation membrane by hot pressing includes: laminating the titanium dioxide nanostructure on the polymer nanostructure; and hot pressing both sides of the separation membrane with a press for 5-15 minutes at 25-50 MPa and 150-250° C.

In another aspect, the present disclosure provides a separation membrane with a titanium dioxide nanostructure bound thereto, including: a separation membrane; a polymer nanostructure laminated on the separation membrane; and a titanium dioxide nanostructure laminated on the polymer nanostructure, wherein the polymer nanostructure is provided between the separation membrane and the titanium dioxide nanostructure and confers adhesive property to the titanium dioxide nanostructure, and the crystalline phase of the titanium dioxide nanostructure consists of anatase phase and rutile phase at a ratio of 8:2-7:3.

A separation membrane with a titanium dioxide nanostructure bound thereto and a method for fabricating the same according to the present disclosure provide the following advantageous effects.

A titanium dioxide nanostructure can be easily deposited and fixed on a separation membrane through electrospinning and hot pressing, and the titanium dioxide nanostructure can be firmly fixed by disposing a polymer nanostructure between the separation membrane and the titanium dioxide nanostructure. Accordingly, exfoliation of titanium dioxide can be prevented and no additional process is required for recovery of titanium dioxide.

Also, since the polymer nanostructure and the titanium dioxide nanostructure fixed on the separation membrane are deposited with a thickness of hundreds of nanometers, they do not block the pores of the separation membrane. Accordingly, a photo degradation by the titanium dioxide nanostructure can be achieved in addition to the filtering effect of the separation membrane itself. In addition, the photo degradation effect can be maximized by optimizing the crystalline phase ratio of the titanium dioxide nanostructure.

Upon irradiation of visible or UV (300-400 nm) light, the titanium dioxide nanostructure fixed on the separation membrane generates OH radicals, thus enabling degradation of organic trace pollutants included in water.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 schematically shows a method for fabricating a separation membrane with a titanium dioxide nanostructure bound thereto according to an exemplary embodiment of the present disclosure, FIG. 1A shows preparation of a polymer nanostructure and a titanium dioxide nanostructure by electrospinning, FIG. 1B shows a titanium dioxide nanostructure and a PVDF nanostructure prepared by electrospinning respectively on a silicon substrate and a separation membrane as well as titanium dioxide separated from the substrate, FIG. 10 shows laminating of titanium dioxide on a PVDF nanostructure followed by hot pressing, and FIG. 1D shows a finally completed separation membrane with a titanium dioxide nanostructure bound thereto;

FIG. 2 is a flow chart describing a method for fabricating a separation membrane with a titanium dioxide nanostructure bound thereto according to an exemplary embodiment of the present disclosure;

FIG. 3 shows SEM images obtained during fabrication of a separation membrane according to the present disclosure, FIG. 3A shows a metal separation membrane, FIG. 3B shows a PVDF nanostructure laminated on a metal separation membrane, and FIG. 3C shows a PVDF nanostructure and a titanium dioxide nanostructure sequentially laminated on a metal separation membrane and hot pressed;

FIG. 4 shows photodegradation efficiency of a separation membrane according to the present disclosure as a function of permeation flux;

FIG. 5 shows photodegradation efficiency of a separation membrane as a function of deposition amount of a titanium dioxide precursor mixture solution;

FIG. 6 compares permeation properties of a separation membrane according to the present disclosure with a separation membrane fabricated by dip coating according to the existing art;

FIG. 7 shows SEM images of the surface of a dip-coated separation membrane;

FIG. 8 shows change in photocatalytic degradation rate of cimetidine by a separation membrane according to the present disclosure and a separation membrane fabricated by dip coating according to the existing art; and

FIG. 9 compares weight of TiO₂ used to fabricate a separation membrane according to the present disclosure and a separation membrane fabricated by dip coating according to the existing art.

### DETAILED DESCRIPTION

In accordance with the present disclosure, a polymer nanostructure and a titanium dioxide nanostructure are formed on a separation membrane by electrospinning and the titanium dioxide nanostructure is fixed to the separation membrane by hot pressing. The polymer nanostructure serves to confer adhesive property so that the titanium dioxide nanostructure can be easily fixed onto the surface of membrane. In the present disclosure, the polymer nanostructure and the titanium dioxide nanostructure respectively means an aggregate of polymer nanowires and an aggregate of titanium dioxide nanowires deposited on the separation membrane.

In accordance with the present disclosure, since the polymer nanostructure and the titanium dioxide nanostructure are formed as nanowires by electrospinning and then laminated on the separation membrane, they do not block the pores of the separation membrane.

A method for fabricating a separation membrane with a titanium dioxide nanostructure bound thereto according to the present disclosure comprises: laminating a polymer nanostructure on a separation membrane; forming a titanium dioxide nanostructure; and fixing the titanium dioxide nanostructure to the separation membrane by hot pressing.

In the laminating the polymer nanostructure on the separation membrane, the polymer nanostructure is laminated on the separation membrane by electrospinning. The polymer nanostructure is provided between the separation membrane and the titanium dioxide nanostructure and serves to fix the titanium dioxide nanostructure. Specifically, the laminating the polymer nanostructure on the separation membrane comprises: preparing a mixture solution comprising a polymer precursor and the separation membrane; and electrospinning the mixture solution to deposit a polymer nanowire on the separation membrane.

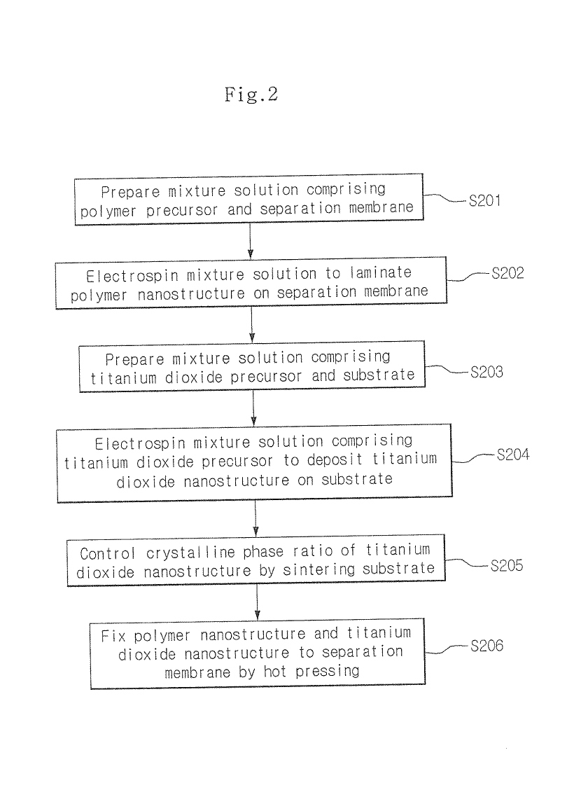

First, the preparing a mixture solution comprising a polymer precursor and the separation membrane (S201 in FIG. 2) will be described in detail.

The mixture solution comprising a polymer precursor comprises a polymer precursor, acetone and N,N-dimethylformamide. For the polymer precursor, a material having superior adhesivity to the separation membrane and a titanium dioxide nanowire is used. Specifically, one selected from polypropylene (PP), polyimide (PI) polysulfone (PSF), polyethersulfone (PES), polyetherimide (PEI), polyphenylene sulfide (PPS) and polyvinylidene fluoride (PVDF) may be used. Among them, polyvinylidene fluoride (PVDF) is the most suitable as the polymer precursor since it has excellent chemical stability, chemical resistance and heat resistance. The separation membrane may be a separation membrane having a plurality of pores, which can be made of either metal, ceramic or polymer material.

Next, the electrospinning the mixture solution to deposit a polymer nanowire on the separation membrane (S202) will be described.

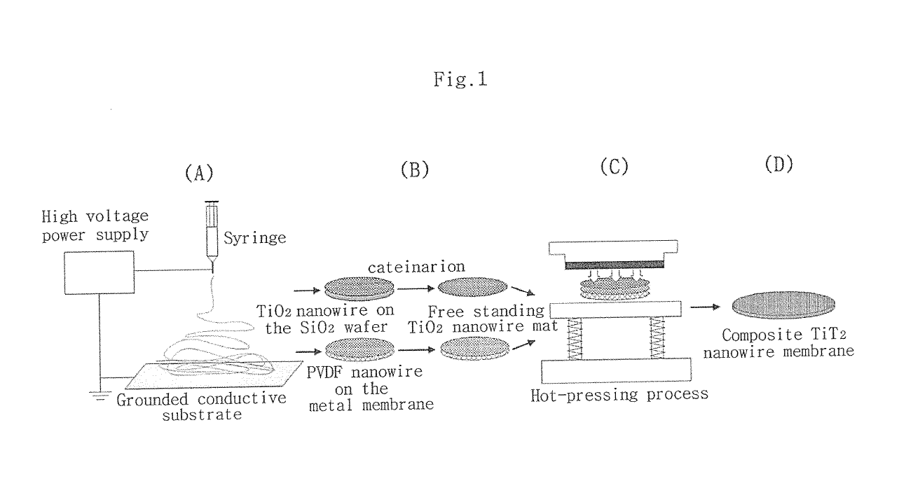

The electrospinning the mixture solution comprising the polymer precursor to deposit a polymer nanowire on the separation membrane is performed using an electrospinning apparatus (see FIG. 1A). The electrospinning apparatus comprises a precursor mixture solution supply unit supplying the mixture solution including the titanium dioxide precursor, an electrospinning nozzle, a chamber and a high voltage generator. The separation membrane is disposed in the chamber. The same electrospinning apparatus is used for electrospinning of the titanium dioxide nanostructure which will be described later. In consideration of the adhesivity of the titanium dioxide nanostructure, the deposition amount of the polymer nanostructure is controlled to 1-5 mL/min.

While the precursor mixture solution is supplied from the precursor mixture solution supply unit to the electrospinning nozzle, a high voltage of 10-20 kV is applied to the electrospinning nozzle by the high voltage generator. Then, the precursor mixture solution in the electrospinning nozzle is transformed into a polymer nanowire according to the principle of electrospinning and sprayed into the chamber. The solvent of the precursor mixture solution is evaporated by the applied high voltage and the polymer nanowire is charged either positively (+) or negatively (−). Meanwhile, the separation membrane disposed in the chamber remains grounded. Accordingly, the polymer nanowire in the chamber is deposited on the separation membrane so as to form the polymer nanostructure (see FIG. 1B).

After the laminating the polymer nanostructure on the separation membrane is completed, the forming the titanium dioxide nanostructure is performed. The forming the titanium dioxide nanostructure comprises: preparing a mixture solution including a titanium dioxide precursor and a substrate; electrospinning the mixture solution to deposit a titanium dioxide nanowire on the substrate; and controlling the crystalline phase ratio of the titanium dioxide nanostructure.

First, the preparing the mixture solution comprising a titanium dioxide precursor and a substrate (S203) will be described in detail.

The mixture solution comprising a titanium dioxide precursor comprises a titanium dioxide precursor (titanium tetraisopropoxide; TTIP), ethanol and a polymer binder for viscosity control. The ethanol serves to increase the viscosity of the precursor and inhibit bead formation. For the polymer binder for viscosity control, polyvinylpyrrolidone (PVP) may be used. Further, the mixture solution may comprise glacial acetic acid which catalyzes the crystallization of titanium dioxide. Specifically, the mixture solution may be stirred at 50-70° C. for 0.5-1 hour. And, the substrate may be a silicon (Si) or quartz (SiO₂) substrate.

Next, the electrospinning the mixture solution to deposit a titanium dioxide nanowire on the substrate (S204) will be described.

As described above, the same apparatus as that used for the electrospinning of the polymer nanowire may be used for the electrospinning of the titanium dioxide nanowire (see FIG. 1A). By electrospinning the mixture solution comprising the titanium dioxide precursor through the electrospinning nozzle, a titanium dioxide nanostructure comprising a titanium dioxide nanowire may be formed on the substrate (see FIG. 1B).

After the titanium dioxide nanostructure is deposited on the substrate, the controlling the crystalline phase ratio of the titanium dioxide nanostructure (S205) is performed. Through this, the crystalline phase ratio of the titanium dioxide nanostructure may be controlled and the optimum crystalline phase ratio may be selected to maximize the photocatalytic activity of the titanium dioxide nanostructure.

Specifically, after the titanium dioxide nanostructure is deposited on the substrate, the separation membrane is sintered at 500-600° C. Through this sintering, the ratio of anatase and rutile crystal phases of titanium dioxide can be controlled. At relatively low temperatures, i.e. near 500° C., the anatase phase becomes dominant. And, at higher temperatures, the rutile phase becomes dominant. Since the highest photocatalytic activity is achieved when the ratio of anatase phase to rutile phase is 7:3, the ratio of anatase phase to rutile phase may be controlled to 7:3-8:2. For this, the sintering is performed at 500-600° C.

After the forming the titanium dioxide nanostructure is completed, the fixing the titanium dioxide nanostructure to the separation membrane by hot pressing (S206) is carried out. First, the titanium dioxide nanostructure obtained from the forming the titanium dioxide nanostructure is laminated on the polymer nanostructure obtained from the laminating the polymer nanostructure on the separation membrane. As a result, the polymer nanostructure and the titanium dioxide nanostructure are sequentially laminated on the separation membrane. The titanium dioxide nanostructure formed on the substrate in the forming the titanium dioxide nanostructure is easily separated from the substrate since it is not bonded to the substrate.

After the polymer nanostructure and the titanium dioxide nanostructure are sequentially laminated on the separation membrane, hot pressing is performed to improve adhesion between the separation membrane and the polymer nanostructure and between the polymer nanostructure and the titanium dioxide nanostructure (see FIG. 10). Specifically, the hot pressing is performed by hot pressing the substrate using a press under constant temperature and pressure. The pressure and temperature are 25-50 MPa and 150-250° C., respectively, and the hot pressing may be performed for 5-15 minutes.

FIG. 1 schematically shows a method for fabricating a separation membrane with a titanium dioxide nanostructure bound thereto according to an exemplary embodiment of the present disclosure. Referring to FIG. 1, FIG. 1A shows preparation of a polymer nanostructure and a titanium dioxide nanostructure by electrospinning, FIG. 1B shows a titanium dioxide (TiO₂) nanostructure (nanowire) and a PVDF nanostructure (nanowire) prepared by electrospinning respectively on a silicon substrate and a separation membrane as well as titanium dioxide separated from the substrate, FIG. 10 shows laminating of titanium dioxide on a PVDF nanostructure followed by hot pressing, and FIG. 1D shows a finally completed separation membrane with a titanium dioxide nanostructure bound thereto.

The method for fabricating a separation membrane with a titanium dioxide nanostructure bound thereto according to an exemplary embodiment of the present disclosure was described above. A separation membrane with a titanium dioxide nanostructure bound thereto was fabricated according to an exemplary embodiment of the present disclosure and its properties were examined as will be described in the following examples.

### Example 1

### Fabrication of Separation Membrane with Titanium Dioxide Nanostructure Bound Thereto

9.0 g of polyvinylidene fluoride (PVDF) was stirred together with a mixture solution (58/42 vol. %) of N,N-dimethylformamide and acetone for 12 hours at 60° C. Thus prepared PVDF mixture solution was sprayed at a rate of 1-5 mL/min to deposit a nanoweb on the surface of a metal separation membrane (STS 316L), which was then dried. Subsequently, TTIP, PVP, glacial acetic acid (1-5 mL) and ethanol (10-20 mL) were mixed and stirred at 50° C. to prepare a titanium dioxide precursor mixture solution. The PVP and TTIP were included in the precursor mixture solution in a total amount of 1-5 g, with 1:2 mass ratio. The titanium dioxide precursor mixture solution was laminated on a PVDF nanostructure of the separation membrane by electrospinning, which was dried at room temperature for 6 hours and sintered at 600° C. After the PVDF nanostructure and a titanium dioxide nanostructure were prepared, the titanium dioxide nanostructure was fixed by hot pressing at 200° C. and 25-50 MPa.

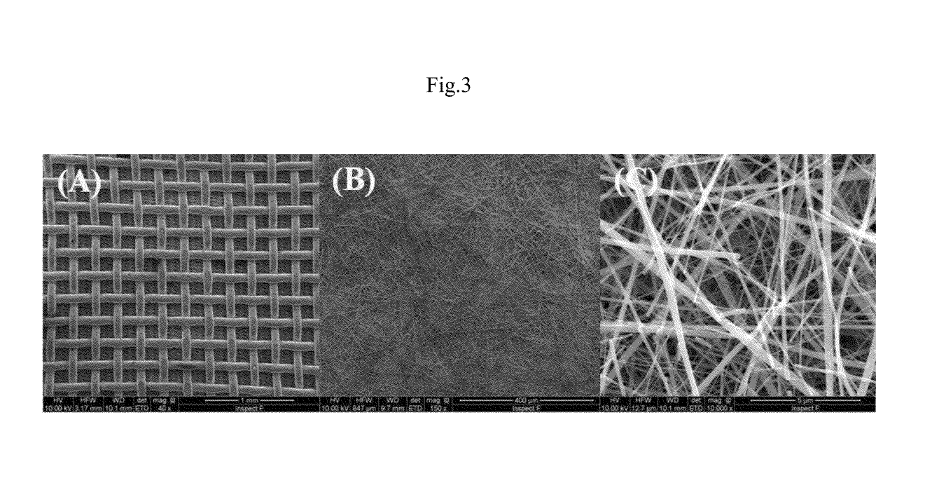

FIG. 3 shows scanning electron microscopic (SEM) images obtained during fabrication of the separation membrane. FIG. 3A shows the metal separation membrane, FIG. 3B shows the PVDF nanostructure laminated on the metal separation membrane, and FIG. 3C shows the PVDF nanostructure and the titanium dioxide nanostructure sequentially laminated on the metal separation membrane and hot pressed. Referring to FIG. 3B, it can be seen that the PVDF nanowire is uniformly distributed on the separation membrane. And, referring to FIG. 3C, it can be seen that the titanium dioxide nanowire of a diameter of approximately 200 nm is stably formed between the separation membrane and the pores.

### Example 2

### Optimization of Photodegradation Efficiency of Separation Membrane with Titanium Dioxide Nanostructure Bound Thereto

In order to optimize the photodegradation efficiency of the separation membrane by the titanium dioxide nanostructure, deposition amount of the titanium dioxide nanowire was varied while fabricating the separation membrane of Example 1.

A separation membrane (TiO₂ nanowire membrane) was fabricated while varying the deposition amount of the titanium dioxide nanowire from 1 to 10 mL/min. The catalytic activity of the fabricated separation membrane was determined using a dead-end flow type reactor. A 10-W BLB lamp (wavelength: 350-400 nm, Philips Co.) was used as light source and 10 μM cimetidine was used as organic pollutant. Cimetidine is a medical substance that may disturb the endocrine system of human and animals and cause negative pharmacological effects when present in the environment. As such, it is one of the pollutants that need to be adequately processed. Since the compound is empirically known not to be directly photodegraded by light, it is useful in investigating the photodegradation efficiency of the separation membrane with a titanium dioxide nanostructure bound thereto.

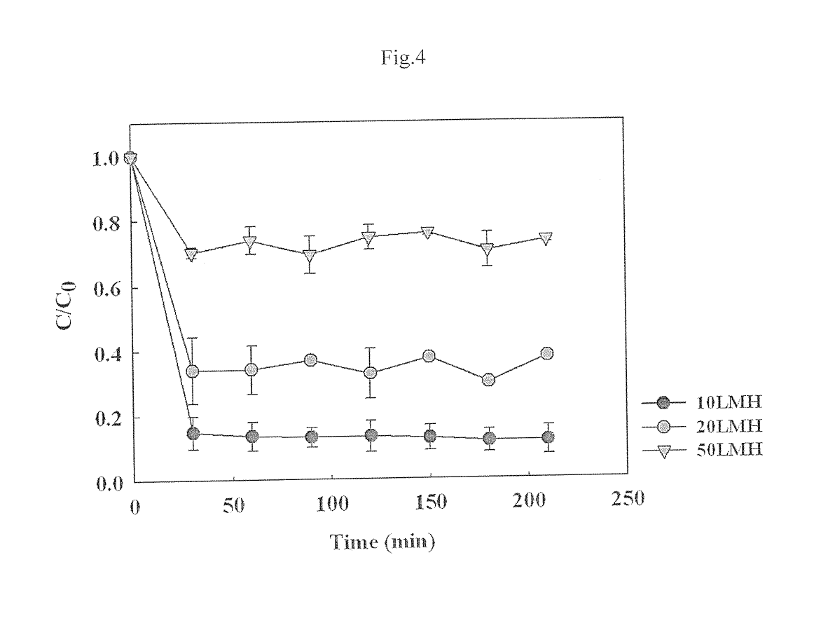

FIG. 4 shows a result of investigating the photodegradation efficiency while controlling permeation flux from 10 to 50 LMH (L/m²·hr). Referring to FIG. 4, it can be seen that a sufficient time for contact with the photocatalyst is necessary for the organic pollutant to be stably degraded and that it is effectively degraded at low permeation flux. Based on this result, the inventors performed photodegradation test at a permeation flux of 10 LMH.

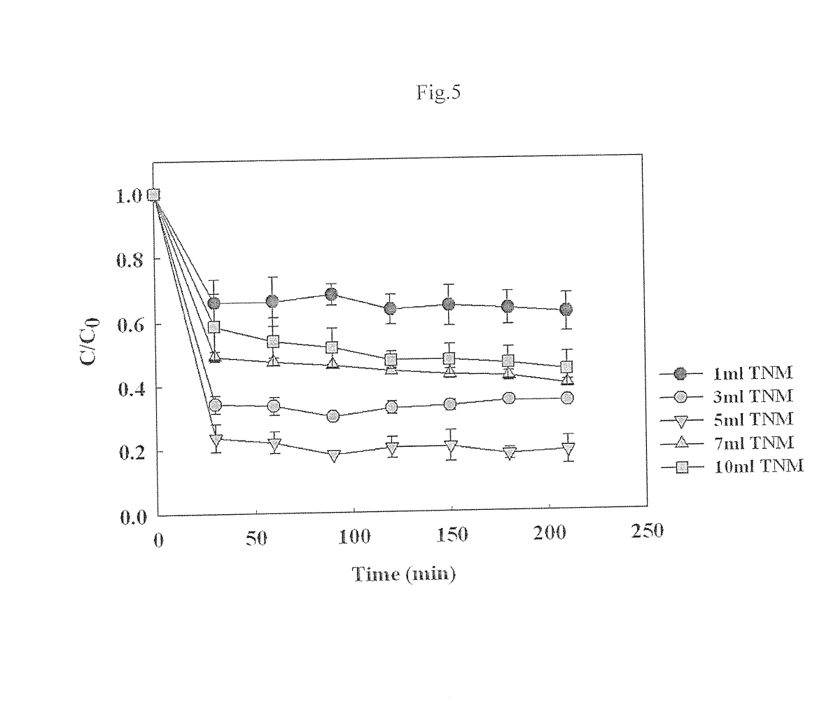

FIG. 5 shows a result of investigating the photodegradation efficiency of the separation membrane with a titanium dioxide nanostructure bound thereto while varying the deposition amount of titanium dioxide nanowire from 1 to 10 mL/min. It can be seen that the photodegradation efficiency of the separation membrane increases proportionally to the deposition amount of the titanium dioxide nanowire, up to 5 mL/min. Especially, the best efficiency was achieved when the deposition amount was 5 mL/min, with about 80% of cimetidine reduced. Meanwhile, the efficiency was relatively lower at 7 mL/min and 10 mL/min. This indicates that there is a limitation in fixing the titanium dioxide nanowire, which can be explained from the experimental result of exfoliation. Accordingly, the deposition amount of the titanium dioxide nanowire resulting in the optimum photodegradation efficiency is 3-5 mL/min. In this case, the spinning distance during electrospinning is 10-15 cm.

### Example 3

### Comparison of Separation Membrane of the Present Disclosure with Dip-Coated Separation Membrane

The permeation property and efficiency of organic pollutant degradation of the separation membrane with a titanium dioxide nanostructure bound thereto (TiO₂ nanowire membrane) fabricated according to Example 2 were compared with those of a separation membrane fabricated by fixing TiO₂ by dip coating.

The TiO₂ dip-coated separation membrane was fabricated as follows. A separation membrane (ceramic or metal membrane) was dipped in a coating solution (TiO₂ Degussa P-25, 1-10 wt %) and then dried at room temperature. After the coating was completed, the separation membrane was heat-treated at 400° C. for 30 minutes. This procedure was repeated 5 times to obtain a dip-coated separation membrane.

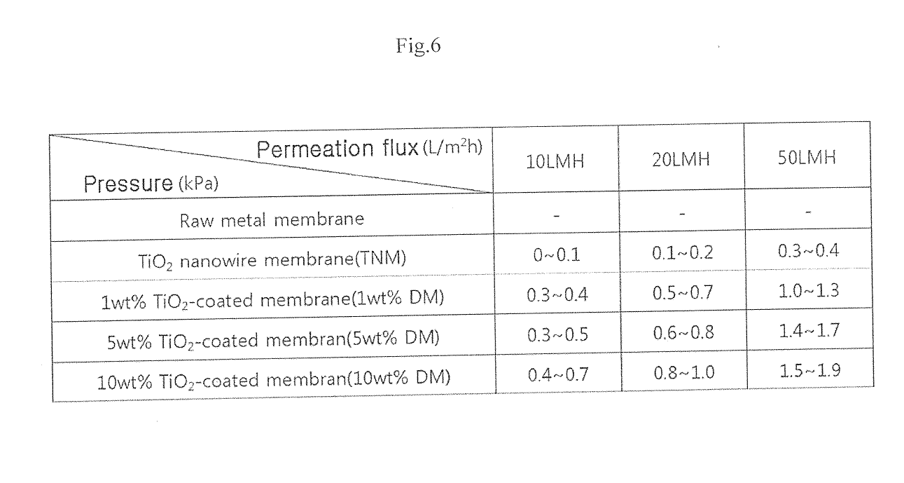

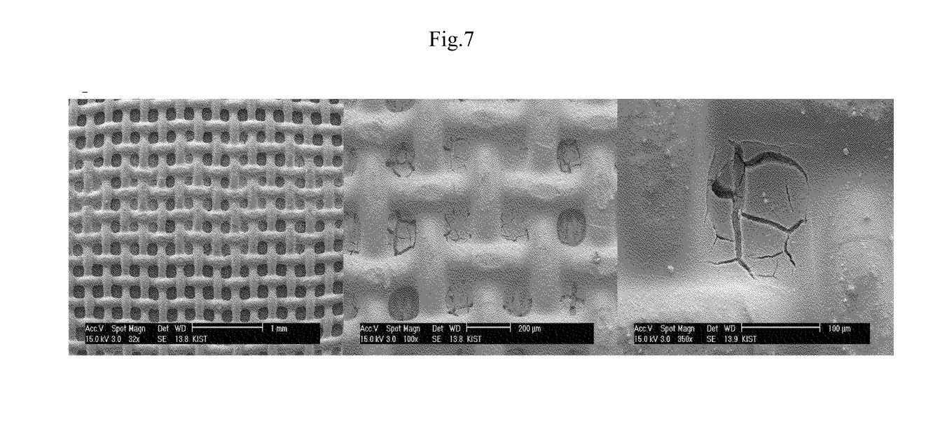

In order to investigate the permeation properties of the titanium dioxide nanowire separation membrane and the dip-coated separation membrane, deionized (DI) water was supplied while varying permeation flux from 10 to 50 LMH. As seen from FIG. 6, change in transmembrane pressure (TMP) with permeation flux was interminable for the separation membrane with no titanium dioxide fixed (raw metal membrane). As for the separation membrane with a titanium dioxide nanostructure bound thereto (TiO₂ nanowire membrane; TNM), the TMP increased up to 0.5 kPa as the permeation flux increased. As for the dip-coated separation membrane (1 wt %, 5 wt % and 10 wt % DM), the TMP increased more steeply with the concentration of the coated photocatalyst as compared to the TNM. Referring to the SEM images of FIG. 7, it can be seen that the dip-coated separation membrane has decreased specific surface area and increased coating layer thickness as the photocatalyst blocked the pores of the separation membrane. Since this may affect the permeation ability and catalytic activity, experiments were carried out repeatedly. As a result, it was found that the TMP decreased again, which may be because the coated TiO₂ that blocked the pores was exfoliated.

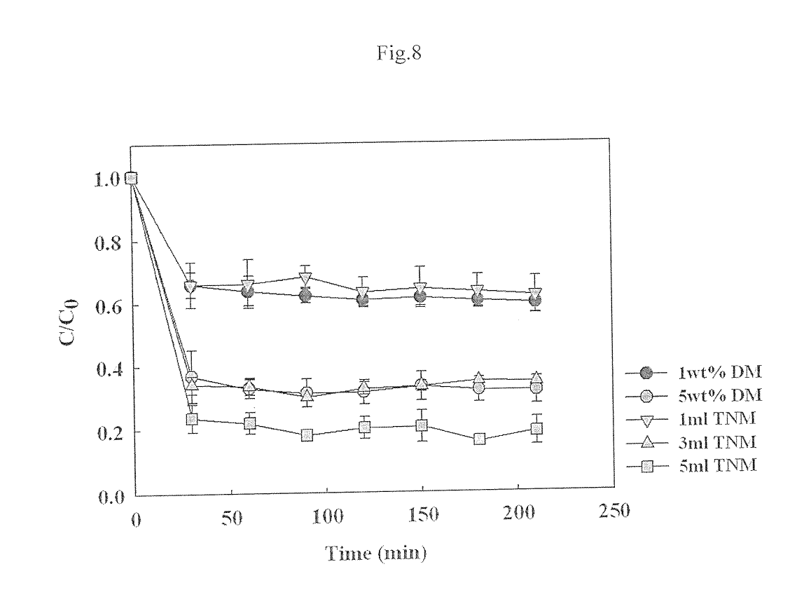

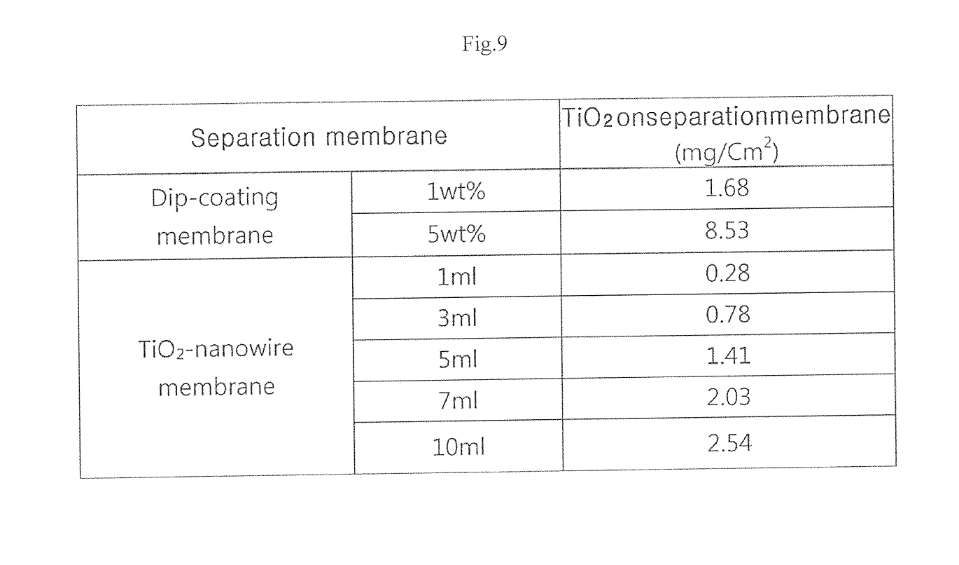

The photodegradation efficiency of the dip-coated separation membrane was investigated by passing 10 μM cimetidine at 10 LMH under the same condition as in Example 2 using a dead-end flow type reactor. FIG. 8 shows a result of comparing the photodegradation efficiency with that of the titanium dioxide nanostructure separation membrane. It was difficult to carry out photodegradation test with the 10 wt % dip-coated separation membrane owing to severe exfoliation of titanium dioxide on the surface of the separation membrane. The 5 wt % dip-coated separation membrane (5 wt % DM) as well as the 3 and 5 mL/min deposited titanium dioxide nanostructure separation membranes (3 mL TNM and 5 mL TNM) showed good photodegradation efficiency. In particular, the 5 wt % dip-coated separation membrane (5 wt % DM) and the 3 mL/min deposited titanium dioxide nanostructure separation membrane (3 mL TNM) showed similar photodegradation efficiency. However, referring to the result of comparing the weight of TiO₂ used to fabricate each separation membrane (FIG. 9), it can be seen that more TiO₂ was used in the 5 wt % dip-coated separation membrane (8.5 mg/cm²) than the 3 mL/min deposited titanium dioxide nanowire separation membrane (0.78 mg/cm²) which showed similar photodegradation efficiency. Accordingly, it was confirmed that, in the titanium dioxide nanostructure separation membrane according to the present disclosure, the titanium dioxide nanowire is stably deposited on the surface of the separation membrane and serves as a photocatalyst and a superior photodegradation effect can be achieved with a small amount of the photocatalyst.

While the exemplary embodiments have been shown and described, it will be understood by those skilled in the art that various changes in form and details may be made thereto without departing from the spirit and scope of the present disclosure as defined by the appended claims.

What is claimed is:

1. A method for fabricating a separation membrane with a titanium dioxide nanostructure bound thereto, comprising:
laminating a polymer nanostructure on a separation membrane;
forming a titanium dioxide nanostructure; and
fixing the titanium dioxide nanostructure to the separation membrane by hot pressing,
wherein said laminating the polymer nanostructure on the separation membrane comprises:
preparing a mixture solution comprising a polymer precursor and the separation membrane; and
electrospinning the mixture solution to deposit a polymer nanowire on the separation membrane.

2. The method for fabricating a separation membrane with a titanium dioxide nanostructure bound thereto according to claim 1, wherein the polymer nanostructure is provided between the separation membrane and the titanium dioxide nanostructure and confers adhesive property to the titanium dioxide nanostructure.

3. The method for fabricating a separation membrane with a titanium dioxide nanostructure bound thereto according to claim 1, wherein the polymer precursor is polyvinylidene fluoride (PVDF).

4. The method for fabricating a separation membrane with a titanium dioxide nanostructure bound thereto according to claim 1, wherein the polymer precursor is one of polypropylene (PP), polyimide (PI) polysulfone (PSF), polyethersulfone (PES), polyetherimide (PEI) and polyphenylene sulfide (PPS).

5. The method for fabricating a separation membrane with a titanium dioxide nanostructure bound thereto according to claim 1, wherein the mixture solution comprising the polymer precursor comprises the polymer precursor, acetone and N,N-dimethylformamide.

6. The method for fabricating a separation membrane with a titanium dioxide nanostructure bound thereto according to claim 1, wherein said forming the titanium dioxide nanostructure comprises:
preparing a mixture solution comprising a titanium dioxide precursor and a substrate;
electrospinning the mixture solution to deposit a titanium dioxide nanowire on the substrate; and
controlling the crystalline phase ratio of the titanium dioxide nanostructure.

7. The method for fabricating a separation membrane with a titanium dioxide nanostructure bound thereto according to claim 6, wherein said controlling the crystalline phase ratio of the titanium dioxide nanostructure comprises controlling the ratio of anatase phase to rutile phase to 8:2-7:3.

8. The method for fabricating a separation membrane with a titanium dioxide nanostructure bound thereto according to claim 6, wherein said controlling the crystalline phase ratio of the titanium dioxide nanostructure comprises sintering the separation membrane with the titanium dioxide nanostructure laminated at 500-600° C.

9. The method for fabricating a separation membrane with a titanium dioxide nanostructure bound thereto according to claim 1, wherein the mixture solution comprising the titanium dioxide precursor comprises a titanium dioxide precursor, ethanol and a polymer binder for viscosity control.

10. The method for fabricating a separation membrane with a titanium dioxide nanostructure bound thereto according to claim 6, wherein, in said electrospinning the mixture solution comprising the titanium dioxide precursor, the spinning is performed at a rate of 3-5 mL/min.

11. The method for fabricating a separation membrane with a titanium dioxide nanostructure bound thereto according to claim 1, wherein, in said electrospinning the mixture solution comprising the polymer precursor, the spinning is performed at a rate of 1-5 mL/min.

12. The method for fabricating a separation membrane with a titanium dioxide nanostructure bound thereto according to claim 1, wherein the separation membrane is a separation membrane having a plurality of pores, which comprises a material selected from a metal material, a ceramic material and a polymer material.

13. The method for fabricating a separation membrane with a titanium dioxide nanostructure bound thereto according to claim 1, wherein said fixing the titanium dioxide nanostructure to the separation membrane by hot pressing comprises:
laminating the titanium dioxide nanostructure on the polymer nanostructure; and
hot pressing both sides of the separation membrane with a press for 5-15 minutes at 25-50 MPa and 150-250° C.

14. A separation membrane with a titanium dioxide nanostructure bound thereto, comprising:
a separation membrane;
a polymer nanostructure laminated on the separation membrane; and
a titanium dioxide nanostructure laminated on the polymer nanostructure,
wherein the polymer nanostructure is provided between the separation membrane and the titanium dioxide nanostructure and confers adhesive property to the titanium dioxide nanostructure, and
the crystalline phase of the titanium dioxide nanostructure comprises anatase phase and rutile phase at a ratio of 8:2-7:3.

15. The separation membrane with a titanium dioxide nanostructure bound thereto according to claim 14, wherein the polymer precursor is polyvinylidene fluoride (PVDF).

16. The separation membrane with a titanium dioxide nanostructure bound thereto according to claim 14, wherein the polymer precursor is one of polypropylene (PP), polyimide (PI) polysulfone (PSF), polyethersulfone (PES), polyetherimide (PEI) and polyphenylene sulfide (PPS).

17. The separation membrane with a titanium dioxide nanostructure bound thereto according to claim 14, wherein the separation membrane is a separation membrane having a plurality of pores, which comprises a material selected from a metal material, a ceramic material and a polymer material.
